(19) United States
(12) Patent Application Publication
(10) Pub. No.: US 2024/0256641 A1
(43) Pub. Date: Aug. 1, 2024

(54) METHOD AND DEVICE FOR CHARACTERISING A USER, AND DEVICE FOR PROVIDING SERVICES USING SAME

(71) Applicant: ORANGE, Issy-les-Moulineaux (FR)

(72) Inventors: Christian Gregoire, CHATILLON CEDEX (FR); Julian Moreira, CHATILLON CEDEX (FR); Nicolas Pellen, CHATILLON CEDEX (FR)

(21) Appl. No.: 18/565,303

(22) PCT Filed: May 30, 2022
(86) PCT No.: PCT/FR2022/051010

§ 371 Date: Nov. 29, 2023

(30) Foreign Application Priority Data
May 31, 2021 (FR) 2105682

(51) Int. Cl. G06F 21/31; G06F 3/16

(52) U.S. Cl. CPC G06F 21/31; G06F 3/167; G06F 2221/2133

(57) ABSTRACT

A method and a device for characterizing a user, in particular a user of a device and/or a service in the field of computer security. The characterization method includes: a comparison of first data associated with a first sound object spatialized at a first location by a user interface of a communication terminal and second data received following the reproduction of the first spatialized sound object, the second data being based on a second spatialized sound object perceived at a second location. The comparison triggers, in the event of a positive result, a characterization of the source of interaction as being a suitable user. Thus, errors in characterizing a user as a suitable user, in particular a human user, are reduced because existing sound and speech recognition systems are not able to select a sound in a spatialized sound environment, i.e. a 3D audio scene.

### CROSS-REFERENCE TO RELATED APPLICATIONS

This Application is a Section 371 National Stage Application of International Application No. PCT/FR2022/051010, filed May 30, 2022, which is incorporated by reference in its entirety and published as WO 2022/254136 A1, on Dec. 8, 2022, not in English.

### TECHNICAL FIELD

The invention relates to the field of computer security. Accordingly, the invention relates to a method and a device for characterizing a user, notably a user of a device and/or a service. The invention relates in particular to the characterization of a user as a human user, as opposed to a computer-generated user or robot user.

### PRIOR ART

At present, the characterization of a user enables a human user to be differentiated from a robot user (that is to say, notably, a computer-generated user implemented by a computer). This characterization uses a CAPTCHA (Completely Automated Public Turing test to tell Computers and Humans Apart) test, or an HIP (Human Interaction Proof) test.

By using a CAPTCHA test, a server receiving data forms can be protected not only against the reception of forms classed as undesirable, or “spam”, because they originate from a robot user, but also against denial of service attacks, that is to say the execution by the server of a large number of unnecessary processes caused by the undesirable forms received. The user of a CAPTCHA test can also reduce network overloading due to denial of service attacks by one or more servers, by avoiding the downloading of documents required by one or more robot users.

There are various types of CAPTCHA test. The most common types are what are known as visual CAPTCHA tests, in which the user enters, when requested, a series of letters matching the distorted letters displayed on the screen, or clicks, in a mosaic of displayed images, the images in the mosaic including a particular object, such as traffic lights.

For some users, however, the presence of a CAPTCHA test for accessing a site or content is simply prohibitive. For example, a visually impaired user cannot complete a visual CAPTCHA test. Furthermore, these verification systems fail to recognize some disabled users as humans, making it impossible for these users to create accounts, write comments or make purchases on some sites. To overcome these accessibility problems, a sound CAPTCHA test may be used. This asks the user to identify, on request, a broadcast sound object, or to enter, on request, a series of digits matching the digits uttered vocally during the broadcast of a sound extract.

However, current recognition systems, namely image recognition and voice recognition, have made considerable progress and are readily available to large numbers of people. These CAPTCHA tests are therefore easily evaded by robots that are correctly programmed to use these image and voice recognition techniques.

To limit the evasion of these CAPTCHA tests, some CAPTCHA systems use visual 3D as an initial measure. For example, the displayed text to be entered by the user is distorted in three dimensions, in order to distort further the letters to be recognized. As a second measure, other sound CAPTCHA systems broadcast the sound extract to be identified (notably words) against a sound background, of the cocktail party effect type for example. However, as recognition techniques are rapidly improving, the latest generations of image and voice recognition systems are increasingly robust to this kind of disturbance.

### SUMMARY

An exemplary embodiment of the invention is a method for characterizing a user, the characterization method comprising a comparison of first data associated with a first sound object spatialized at a first location by a user interface of a communication terminal and second data received following the reproduction of the first spatialized sound object, the first data being distinct from the first sound object, the second data being based on a second spatialized sound object perceived at a second location, the comparison triggering, in the event of a positive result, a characterization of the source of interaction as being a suitable user.

Thus, only an appropriate user, notably a human user, is capable of supplying second data matching the first data because he is the only user capable of providing the location of a given spatialized sound object or a characteristic of a spatialized sound object broadcast at a given location, or even the answer to a voice question broadcast at a given location. This is because existing sound and voice recognition systems are not capable of selecting a sound in a spatialized sound environment, i.e. a 3D (three-dimensional) audio scene.

Advantageously, the comparison result is positive when the first data and the second data are based on a same location, the first location of the first spatialized sound object associated with the first data is identical to the second location of the second spatialized sound object associated with the second data.

Thus, only an appropriated user, notably a human user, being capable to perceive correctly the location of a sound spatialized object, only this appropriated user will perceive the second spatialized sound object matching the first reproduced spatialized sound object and will supply therefore the second data matching the first data because they are based on the same location.

Advantageously, the first data and the second data belong to one of the following types of data:
a location parameter of a spatialized sound object;
a category of sound object generating source;
an answer to a question voiced in a sound object.

Thus an exemplary embodiment of the invention reduces the errors in the characterization of a user as a human user or a robot user using a sound recognition system, because these systems are not capable of:
either determining the location of a given sound object. The user characterization errors are reduced;
or, even less, executing their processing on a sound object broadcast at a given location in a sound environment captured and processed by these recognition systems to determine the sound object source category; consequently, the user characterization errors are limited even further.
or, even less, answering a question posed by the sound object. In fact, this requires not only the voice recognition of a sound object broadcast in a spatialized manner at a given location in a spatialized sound environment, but also a search for an answer to the question recognized by the voice recognition.

Therefore, recognition errors caused by the difficulty encountered by the voice recognition system in extracting the broadcast sound object from the spatialized sound environment lead to errors in the answer, because the recognized question processed by the search engine will be incorrect. The user characterization errors therefore become very small.

Advantageously, the characterization method comprises reproducing a request for interaction at the first spatialized sound object, the interaction request being intended for the user, and the second data are data received after the reproduction of said interaction request.

Advantageously, the interaction request comprises the type of second data expected during the interaction.

Advantageously, the interaction request further comprises the second location of the second spatialized sound object, the second location matching the first location.

Thus the location of the sound object that the user has to hear in order to characterize it may vary from one characterization to another, reducing the risks that computer systems may learn the location, and therefore reducing the risks of characterization errors.

Advantageously, the user characterization method characterizes the user of at least one of the following elements:
a service implemented by a service provision device;
a device from among the following devices:
   the communication terminal;
a local or network processing device;
a service provision device;
a communication network equipment to which a communication terminal of the user is connected.

Advantageously, the characterization method comprises a check implemented by the user interface, the check checking the user interface by means of a spatialized reproduction command comprising the first sound object and the first location.

Advantageously, the check causes the activation of the capture of second data by the user interface, the captured data comprising the received second data.

Advantageously, according to an exemplary implementation of the invention, the various steps of the method according to the invention are executed by a computer program or software, this software comprising software instructions intended for execution by a data processor of a device forming part of a characterization device and/or of a service provision device, and being designed to command the execution of the various steps of this method.

An exemplary embodiment of the invention thus also proposes a program comprising program code instructions for executing the steps of the method as claimed in any of the preceding claims when said program is executed by a processor.

This program may use any programming language, and may be in the form of source code, object code, or a code intermediate between source and object code, such as a code in partially compiled form, or any other desirable form.

Another exemplary embodiment of the invention is a device for characterizing a user, the characterization device comprising a comparator of first data associated with a first sound object spatialized at a first location by a user interface of a communication terminal and second data received following the reproduction of the first spatialized sound object, the first data being distinct from the second sound object, the second data being based on a second spatialized sound object perceived at a second location, the comparator triggering, in the event of a positive result, a characterization of the source of interaction as being an appropriate user.

Another exemplary embodiment of the invention is a service provision device, the service provision device comprising:
a processor for implementing at least one service;
an exchange interface for exchanges with a communication terminal; and
a device for characterizing a user of the service, comprising a comparator of first data associated with a first sound object spatialized at a first location by a user interface of the user's communication terminal and second data received following the reproduction of the first spatialized sound object, the first data being distinct from the first sound object, the second data being based on a second spatialized sound object perceived at a second location, the comparator triggering, in the event of a positive result, a characterization of the source of interaction as being an appropriate user, and commanding the processor to implement the service..

### BRIEF DESCRIPTION OF THE DRAWINGS

The characteristics and advantages of one or more exemplary embodiments of the invention will be more clearly apparent from a perusal of the following description, provided by way of example, and of the appended drawings, of which:

FIG. 1 shows a simplified diagram of a user characterization method according to an exemplary embodiment of the invention,

FIG. 2 shows a simplified diagram of a 3D audio scene used by an exemplary embodiment of the invention,

FIG. 3a shows a simplified diagram of a user interface of a first embodiment of the invention in the event of an interaction request relating to a position of a sound object,

FIG. 3b shows a simplified diagram of a user interface of a second embodiment of the invention in the event of an interaction request relating to a position of a sound object,

FIG. 4a shows a simplified diagram of a user interface of a first embodiment of the invention in the event of an interaction request relating to a category of a sound object,

FIG. 4b shows a simplified diagram of a user interface of a second embodiment of the invention in the event of an interaction request relating to a category of a sound object,

FIG. 5a shows a simplified diagram of a user interface of a first embodiment of the invention in the event of a sound object comprising an interaction request,

FIG. 5b shows a simplified diagram of a user interface of a second embodiment of the invention in the event of a sound object comprising an interaction request,

FIG. 6 shows a simplified diagram of a communication architecture comprising a characterization device according to an exemplary embodiment of the invention.

### DESCRIPTION OF THE EMBODIMENTS

In the context of the spatialized broadcasting of sound, or 3D sound, that is to say the 3D reproduction of an audio scene, the various virtual objects of the audio scene emitting a sound signal, or sound, form a sound object. The spatialization of these sound objects in a given location enables the listener to perceive these sound objects as if they were emitting from this location in the three-dimensional environment surrounding the listener. For this purpose, an exemplary embodiment of the invention uses the known techniques of sound spatialization, notably binaural synthesis techniques or techniques using acoustic transfer functions or binaural filters (HRTF, for Head Related Transfer Functions). The advantage of the use of binaural filters and a helmet using such filters is that it is inexpensive to implement and can therefore be used by a large number of people, making it, notably, particularly suitable for user characterization. An exemplary embodiment of the invention may also use other sound spatialization techniques, notably in surrounds, such as transaural, WSF, Ambisonic, 5.1 and other techniques.

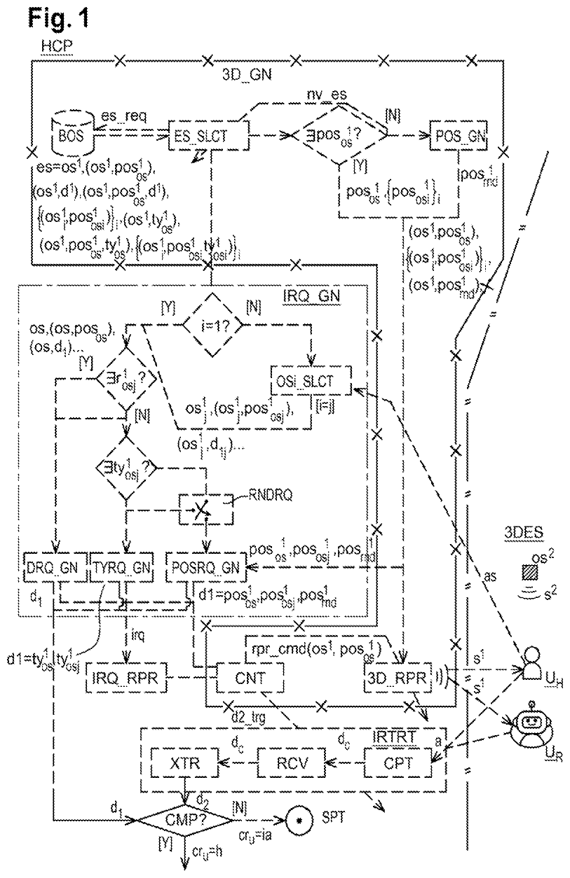

FIG. 1 shows a simplified diagram of a user characterization method according to an exemplary embodiment of the invention.

The characterization method HCP comprises a comparison CMP of first data d1 associated with a first sound object OS₁ spatialized at a first location posₒₛ₁ of a spatialized audio scene ES by a user interface of a communication terminal, and of spatialized sound object d2 received following the reproduction 3D_RPR of the first spatialized sound object OS₁. The first data d1 are distinct from the first sound object OS₁. The second data d2 are based on a second spatialized sound object OSP₂ perceived at a second location posₒₛₚ₂ of the spatialized audio scene 3DES. In the event of a positive result [Y], the comparison CMP triggers a characterization of the interaction source as being an appropriate user cr_{U}=h.

In particular, the comparison CMP result is positive [Y] when the first data d1 and the second data d2 are based on a same location posₒₛ, the first location posₒₛ₁ of the first spatialized sound object OS₁ associated with the first data d1 is identical to the second location posₒₛₚ₂ of the second spatialized sound object OSP₂ associated with the second data d2.

In particular, the first data d1 and the second data d2 are one of the following types of data:
a location parameter posₒₛ of a spatialized sound object OS;
a category tyₒₛ of a generating source of a sound object OS;
an instant tₒₛ or an order of reproduction of the sound object OS in a sound environment consisting of a series of sound objects;
an answer to a question vocalized in a sound object OS.

“Generating source category” may be taken to refer to classes of category, such as machines, animals, machines, natural sources, etc., and/or subclasses such as vehicles, household appliances, industrial machinery, etc. for machines; dogs, cats, cows, snakes, whales, etc. for animals; rain, wind, storm, etc. for natural sources, and/or sub-subclasses such as cars, airplanes, trains and the like.

In particular, the characterization method HCP comprises a reproduction IRQ_RPR of an interaction request irq at the first spatialized sound object OS₁. The interaction request irq is intended for the user UH, UR. The second data d2 are data received dr following the reproduction of said interaction request IRQ_RPR.

In particular, the interaction request irq comprises the type ty²ₒₛ of second data d2 expected during the interaction a.

In particular, the interaction request irq further comprises the second location pos²ₒₛ of the second spatialized sound object OS². In this case, the second location pos²ₒₛ corresponds to the first location pos¹ₒₛ: pos²ₒₛ=pos¹ₒₛ.

In particular, the user characterization method HCP characterizes the user of at least one of the following elements:
a service implemented by a service provision device;
one of the following devices:
   the communication terminal;
a local or network processing device;
a service provision device;
a communication network equipment to which a communication terminal of the user is connected.

In particular, the characterization method HCP comprises a check CNT implemented by the user interface. The check CNT checks the user interface by means of a spatialized reproduction command rpr_cmd comprising the first sound object OS₁ and the first location pos¹ₒₛ.

In particular, the check CNT triggers d2_trg an activation of a data capture CPT by the user interface. The captured data dc comprise the second data received d2.

In particular, the characterization method HCP comprises a selection of a sound environment ES_SLCT in a storage device BOS, such as a memory or a database, comprising one or more predefined sound environments. In particular, the database is a database of sounds or a database of sound objects, or even a database of sound environments. A stored predefined sound environment es comprises one or more sound objects os¹, {os¹ᵢ}ᵢ. If appropriate, a sound object os¹, {os¹ᵢ}ᵢ is associated with one or more of the following characteristic parameters:
a predefined location pos¹ₒₛ, {pos¹ₒₛᵢ}ᵢ,
a category of sound sources ty¹ₒₛ, {ty¹ₒₛᵢ}ᵢ,
an instant {t¹ₒₛᵢ}ᵢ or an order of reproduction of the sound object OS in a sound environment consisting of a series of sound objects {OS¹ᵢ}ᵢ;
an answer r¹ₒₛ to a vocalized question included in the sound object, the answer r¹ₒₛ forming the first data d1,
etc.

Thus the sound environment selection ES_SLCT receives from the storage device BOS a sound environment es composed of:
either one or more first sound objects OS₁, {OS¹ᵢ}ᵢ,
or one or more pairs formed by:
   a first sound object and a first location (OS¹, pos¹ₒₛ), {(OS¹ᵢ, pos¹ₒₛᵢ)}ᵢ, or
   a first sound object and a first category of sound sources (OS¹, ty¹ₒₛ), {(OS¹,ty¹ₒₛᵢ)}ᵢ, or
   a first sound object and a first answer to a vocalized question included in the first sound object (OS¹, r¹ₒₛ=d1), {(OS¹ᵢ, r¹ₒₛᵢ)}ᵢ,
   etc.
or one or more n-uplets formed by a first sound object and one or more of the following parameters: a first location, a first sound source category, a first answer, etc. (OS¹, pos¹ₒₛ, ty¹ₒₛ), {(OS¹ᵢ, pos¹ₒₛᵢ, ty¹ₒₛᵢ)}ᵢ, (OS¹, pos¹ₒₛ, r¹ₒₛ=d1), {(OS¹ᵢ, pos¹ₒₛᵢ, r¹ₒₛᵢ)}ᵢ, (OS¹, ty¹ₒₛ, r¹ₒₛ=d1), {(OS¹ᵢ, ty¹ₒₛᵢ, r¹ₒₛᵢ}ᵢ(OS¹, pos¹ₒₛ, ty¹ₒₛ, r¹ₒₛ=d1), {(OS¹ᵢ, pos¹ₒₛᵢ, ty¹ₒₛᵢ, r¹ₒₛᵢ)}ᵢ, etc. Notably, the sound environment selection ES_SLCT sends a sound environment request es_req to a storage device such as a memory or a database BOS. Thus the sound environment selection ES_SLCT receives the sound environment es in response to the sound environment request es_req.

In particular, the sound environment selection ES_SLCT selects only a 3D sound environment, that is to say at least a first sound object associated with a first location allowing a spatialized reproduction of the first sound object at the first location. In order to execute a selection of a 3D sound environment only, the sound environment request comprises a parameter indicative of the 3D sound environment request, and/or is sent only to a storage device BOS comprising only 3D sound environments.

Alternatively, the characterization method HCP comprises a verification ∃posₒₛ¹? of the presence of a first location or locations in the received sound environment es. Thus, if the received sound environment es comprises no first location:
either the verification ∃posₒₛ¹? triggers nv_es a new sound environment selection ES_SLCT until the received sound environment comprises a first location of a first sound object;
or the characterization method HCP comprises a location generator POS_GN providing a first sound object of the sound environment with a first generated location pos¹_{rnd}. In particular, the location generator is a random location generator or a location generator based on at least one parameter of the sound object (for example, depending on the sound object category, the sound object will be positioned on the ground or at a lower level, etc.)

Thus the selected sound environment es will be supplied to the spatialized sound reproduction 3D_RPR which will reproduce the first sound signal s¹ of the first sound object OS¹ as if the sound object were located at the first location pos¹ₒₛ in the spatialized audio scene 3DES.

In order to create a favorable three-dimensional sound environment ES for the characterization of a user, the characterization method HCP comprises, notably, a creation 3D_GN of a three-dimensional sound environment 3DES. The creation 3D_GN of a three-dimensional sound environment comprises, notably, the spatialized reproduction of a sound object 3D_RPR. The spatialized reproduction of a sound object makes it possible, notably, to broadcast a sound, or sound signal, s associated with the sound object OS as if it had been emitted from a location posₒₛ matching the location associated with the sound object OS in the three-dimensional sound environment 3DES.

In particular, the creation 3D_GN of a three-dimensional sound environment 3DES further comprises at least one of the following steps:
selecting a sound environment ES_SLCT;
verifying the presence of the first location ∃posₒₛ¹?;
generating a location POS_GN.

In particular, the interaction request irq relates to one or more first sound objects. FIG. 1 shows the case where the interaction request concerns a first sound object. Either the selected sound environment es comprises only one first sound object OS¹, in which case the interaction request irq applies to this first sound object OS¹. Or the selected sound environment es comprises a plurality of first sound objects {OS¹ᵢ}ᵢ, in which case the characterization method HCP comprises a selection OSi_SLCT of one sound object from among the set of first sound objects {Os1i}i¹ᵢ}ᵢ of the selected sound environment es. The sound object selection OSi_SLCT then supplies [i=j] one of the first sound objects OS¹ⱼ of the selected environment es, or possibly a pair formed by:
the first sound object selected and a first location (OS¹ⱼ, pos¹ₒₛⱼ), or
the first sound object selected and a first category of sound sources (OS¹ⱼ,ty¹ₒₛⱼ), or
the first sound object selected and a first instant or reproduction order number of the first sound object selected, from the first series of first sound objects SO¹ₒₛ forming the selected environment (OS¹ⱼ,t¹ₒₛⱼ), or
the first sound object selected and a first answer to a vocalized question included in the first sound object (OS¹ⱼ, r¹ₒₛⱼ),
etc.
or one or more n-uplets formed by the first sound object selected and one or more of the following parameters: a first location, a first category of sound sources, a first instant of reproduction, a first answer, etc. (OS¹ⱼ, pos¹ₒₛⱼ, ty¹ₒₛⱼ), (OS¹ⱼ, pos¹ₒₛⱼ, r¹ₒₛⱼ), (OS¹ⱼ, ty¹ₒₛⱼ, r¹ₒₛⱼ), (OS¹ⱼ, pos¹ₒₛⱼ, ty¹ₒₛⱼ, r¹ₒₛⱼ), etc.

In particular, the characterization method HCP comprises a verification of the number of sound objects in the selected sound environment i=1 ?. If the verification of the number of sound objects i=1 ? counts more than one sound object in the selected sound environment es [N], then the verification of the number of sound objects i=1 ? triggers the selection OSi_SLCT of a sound object in the selected sound environment es.

In particular, the characterization method HCP comprises a generation IRQ_GN of an interaction request irq concerning a first sound object, namely a single sound object OS¹ or a selected sound object OS¹ⱼ of the selected sound environment es. The interaction request irq relates to one or more characteristic parameters of the first sound object OS¹, OS¹ⱼ.

In particular, the characterization method HCP comprises a generation of an interaction request relating to the location of the first object POSRQ_GN. If the reproduced sound environment es comprises only a single sound object, the interaction request may simply relate to the position of the perceived sound. However, if the reproduced sound environment es comprises a plurality of sound objects, the interaction request irq may comprise a characteristic parameter of the first sound object selected OS¹ⱼ for which the interaction request irq requires an interaction relating to the position of the perceived sound for this first object selected. For example, the interaction request irq will indicate the category ty¹ₒₛⱼ of sound source to be positioned in the spatially reproduced sound environment.

In particular, the characterization method HCP comprises a generation of an interaction request relating to the category of the first sound object TYRQ_GN. The generation of a request relating to the category TYRQ_GN is used in the case of a sound environment es comprising a plurality of first sound objects, and the interaction request irq comprises the first location associated with the first sound object selected OS¹¹ and relates to the category of the source emitting the perceived sound. For example, the interaction request irq will indicate the location pos¹ₒₛⱼ of the first spatially reproduced sound object for which the user must identify the sound source category.

In particular, the characterization method HCP comprises a generation of an interaction request relating to a question vocalized in the first sound object DRQ_GN. The generation of a request relating to a vocalized question DRQ_GN is used in the case of a sound environment es comprising a plurality of sound objects, the interaction request irq comprises the first location associated with the first sound object selected OS¹ⱼ and relates to the question vocalized in the perceived sound. For example, the interaction request irq will indicate the location pos¹ₒₛⱼ of the first spatially reproduced sound object, the first sound object comprising a vocalized question to which the user has to provide an answer.

In particular, the characterization method HCP comprises at least a verification of the presence of at least one characteristic parameter associated with the first sound object selected OS¹ⱼ: notably, a verification of the presence of an answer to a question vocalized in the first sound object selected ∃rₒₛⱼ¹?, a verification of the presence of a category of the first object selected ∃tyₒₛⱼ¹?, etc. If the presence of a characteristic parameter is verified [Y], ∃rₒₛⱼ¹?, ∃tyₒₛⱼ¹?, respectively, then the generation of an interaction request relating to this characteristic parameter, DRQ_GN, TYRQ_GN respectively, is implemented.

In particular, the characterization method HCP comprises a verification ∃SOₒₛ¹={(OSᵢ¹=OS¹(tₒₛᵢ¹), tₒₛᵢ¹)}ᵢ? of the presence of a series of first sound objects in the sound environment selected (not illustrated). If the verification of the presence of at least one series ∃SOₒₛ¹={(OSᵢ¹=OS¹(tₒₛᵢ¹), tₒₛᵢ¹)}ᵢ? detects a first series of first sound objects [Y], then it triggers a generation of a request relating to the first series of first sound objects SORQ_GN (not illustrated). If appropriate, notably if the sound environment comprises a plurality of first series of first sound objects, a positive result [Y] of the verification of the presence of at least a first series ∃SOₒₛ¹={(OSᵢ¹=OS¹(tₒₛᵢ¹), tₒₛᵢ¹)}ᵢ? triggers a selection of a first series of first sound objects in the sound environment SO_SLCT (not illustrated) before the generation SORQ_GN of a request relating to the first series of first sound objects selected. The series of sound objects are always composed of sound objects whose sound signals are broadcast/emitted one after another, that is to say successively, with or without intervals of silence. In a series of sound objects, the sound objects may have a characteristic parameter whose value is common to all the sound objects in the series. For example, a series of sound objects having the same source categories, a series of sound objects in which all the sound objects have an identical location, etc.

In particular, if a plurality of characteristics are present, then:
either the characterization method HCP comprises a plurality of generations of specific requests, for example a generation of a request relating to an answer DRQ_GN and a generation of a request relating to a source category TYRQ_GN. For example, the question may be asked for different categories of person, such as man, woman, child, different accents, etc. Thus the generated interaction request irq comprises the specific interaction requests supplied by each of the specific request generations;
or the characterization method HCP comprises a request selection RNDRQ that selects one of the specific request generations available: for example, a generation of a request relating to an answer DRQ_GN, or a generation of a request relating to a source category TYRQ_GN, or another type. The request selection RNDRQ may be made randomly or according to the value of one of the characteristic parameters;
or the characterization method HCP automatically implements the generation of a predefined specific request, for example the generation of the request relating to an answer DRQ_GN.

In a particular embodiment of the invention, the selection of a first sound object OS¹ᵢ_SLCT in the sound environment or the selection of a series of sound objects SO_SLCT is executed on a selection action (“as”) for selecting a user UH, UR. In particular, the selection action as comprises a value of a characteristic parameter of the first sound object selected, or of the first series of first sound objects, distinct from the values of this parameter of the other first sound objects in the sound environment, or of the other first series of first sound objects, respectively. For example, in a sound environment consisting of animal noises, the user indicates that the category of the sound object is “donkey”, and the characterization method sends an interaction request to the location of this donkey in the spatialized sound environment.

In particular, the generation IRQ_GN of an interaction request irq comprises one or more of the following steps:
the verification of the number of sound objects in the sound environment selected, i=1?;
if appropriate, the selection of a sound object OSi_SLCT in the sound environment selected;
the verification of the presence of at least one characteristic parameter associated with the first sound object selected OS¹ⱼ: notably, the verification of the presence of an answer to a question vocalized in the first sound object selected ∃rₒₛⱼ¹?, the verification of the presence of a category of the first object selected ∃tyₒₛⱼ¹?, etc.;
at least one generation of a specific interaction request, notably the generation of an interaction request relating to the location of the first object POSRQ_GN, and/or the generation of an interaction request relating to the question vocalized in the first sound object DRQ_GN, and/or a generation of a request relating to a source category TYRQ_GN, etc.
the request selection RNDRQ;
etc.

The generation of an interaction request IRQ_GN and/or the generation or generations of specific requests DRQ_GN, TYRQ_GN, POSRQ_GN, SO_SLCT supply an interaction request irq relating to a first sound object, or even to a first series of first sound objects, possibly comprising one or more specific requests relating to a characteristic parameter associated with the first sound object, or even to the first series of first sound objects, or to a reproduction of an interaction request IRQ_RPR. The reproduction of an interaction request IRQ_RPR is, notably, a visual reproduction such as a display on a screen, a virtual or augmented reality headset, etc. (the visual reproduction taking place before, or simultaneously with, the reproduction of the spatialized sound environment 3D_RPR) and/or a sound reproduction preceding the reproduction of the spatialized sound environment 3D_RPR.

In particular, the reproduction of the spatialized sound environment 3D_RPR is triggered by one of the following steps: selection of the sound environment ES_SLCT, generation of a location, generation of an interaction request IRQ_GN, or reproduction of an interaction request IRQ_RPR.

Following the reproduction of the interaction request IRQ_RPR, the user U_{H}, U_{R} responds a by supplying second data d2 relating to a second sound object OS². The second sound object OS² is the sound object whose second sound signal or second sound s² is perceived by the user in the reproduced spatialized sound environment 3DES which, for the user, corresponds to the first sound object OS1 to which the reproduced interaction request irq relates.

The characterization method HCP receives these second data d2 from the user. Notably, the characterization method HCP comprises one or more of the following steps:
capture CPT of a user action a, supplying captured data dc;
data reception RCV for receiving data from a user interface, notably captured data dc or an action a, and for supplying received data dr;
extraction XTR of second data from received data dr and/or captured data dc.

In particular, the creation of a spatialized sound environment 3D_GN and/or the check of reproduction CNT and/or the reproduction of the sound environment 3D_RPR trigger an interaction processing IRTRT and/or a capture CPT and/or a reception of data RCV.

In particular, the characterization method HCP comprises an interaction processing IRTRT implementing the processing of a user action following the reproduction of the interaction request IRQ_RPR supplied to the comparison of the second data d2. The interaction processing IRTRT comprises one or more of the following steps:
capture CPT of a user action a, supplying captured data dc;
data reception RCV for receiving data from a user interface, notably captured data dc or an action a, and for supplying received data dr;
extraction XTR of second data from received data dr and/or captured data dc.

In particular, the comparison CMP triggers, in the event of a positive result [N], the characterization of the interaction source as being an inappropriate user cr_{U}=ia.

In a particular embodiment, the characterization method HCP is triggered by a service provision method that is not illustrated, particularly before the provision of the service. The service provision will be triggered by the characterization of the interaction source as an appropriate user, in particular a human user. If necessary, in the event of the characterization of the interaction source as an inappropriate user, particularly a robot user or software agent, the characterization method triggers a stop STP of the implementation of the service provision method.

In a particular embodiment, the characterization method HCP is triggered by method for accessing a third-party device (communication terminal, connected object, remote equipment, or other) that is not illustrated, particularly before the authorization of access to the third-party device. Access to the device will be triggered by the characterization of the interaction source as an appropriate user, in particular a human user. If necessary, in the event of a characterization of the interaction source as an inappropriate user, particularly a robot user or software agent, the characterization method triggers a stop STP of the implementation of the method for accessing the third-party device.

A particular embodiment of the characterization method is a program comprising program code instructions for executing the steps of the characterization method when said program is executed by a processor.

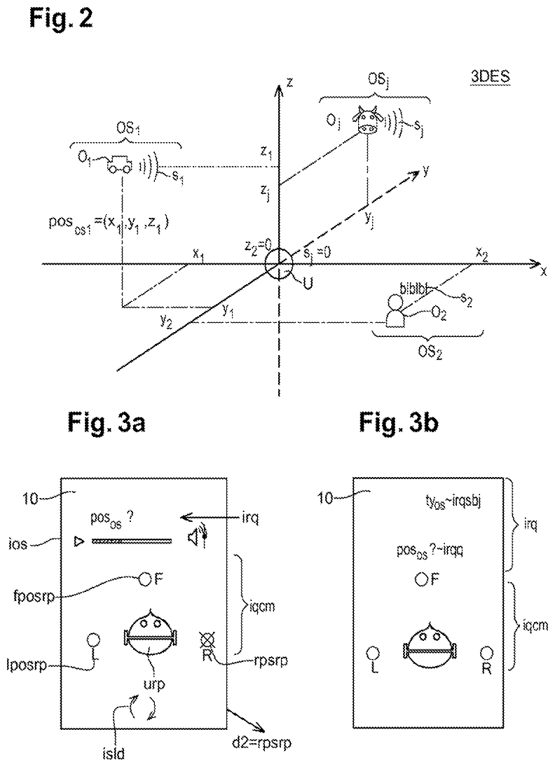

FIG. 2 shows a simplified diagram of a 3D audio scene used by an exemplary embodiment of the invention.

An exemplary embodiment of the invention is based on the positioning of sound objects in a 3D audio scene as elements to be characterized at the human-machine interface. The spatialized sound environment or 3D audio scene 3DES, composed of sound objects, is reproduced around a user U to be characterized. In FIG. 2, the three-dimensional space around the user U is shown schematically as a plane defined by three axes centered on the user U: an abscissa axis x, an ordinate axis y and an azimuth axis z. The sound objects OS₁, OS₂, . . . , OSⱼ, . . . are shown in this three-dimensional space. A sound object OS₁, OS₂, . . . , OSⱼ, . . . is an object O₁, O₂, . . . , Oⱼ, . . . , such as a car, a person, or an animal, in this case a cow, positioned at a location posₒₛ₁, posₒₛ₂, . . . , posₒₛⱼ, . . . in space (defined, notably, by coordinates in these space such as, respectively, posₒₛ₁=(x₁,y₁,z₁), posₒₛ₂=(x₂,y₂,z₂=0), . . . , posₒₛⱼ=(xⱼ=0,yⱼ,zⱼ), . . . in our example of FIG. 2, and emitting a sound signal or sound s₁, s₂, . . . , sⱼ, . . . .

FIGS. 3a, 3b, 4a, 4b, 5a and 5b show simplified diagrams of a user interface in different embodiments of the invention in the event of different types of interaction request, namely those relating, respectively, to a position of the sound object, to a category of the sound object, or to an interaction request included in the sound object.

The characterization method according to an exemplary embodiment of the invention therefore proposes that, in order to create a CAPTCHA test, the user U be presented, notably in an audio headset with binaural technology, with spatialized sounds of different kinds in a sound scene and/or in a certain order (at a certain instant of reproduction, for example). In order to respond, the user must, for example, indicate the location of a certain type of sound among those presented, and must indicate at which position he hears them (on the left, in front, on the right, etc.); in short, he must locate a sound in a virtual space, as shown in FIGS. 3a and 3b. He may also have to answer the question heard in his right ear, for example (with different questions on the right, on the left, or above), as shown in FIGS. 5a and 5b. Since the combination of recognition of a type of sound and its position is complicated for a machine, this makes it possible to determine whether or not the responder is human.

FIG. 3a shows a simplified diagram of a user interface of a first embodiment of the invention in the case of an interaction request relating to a position of a sound object.

The simplest case implemented by the characterization method will therefore be a single first sound s¹ emitted from a first location pos¹ₒₛ (that is to say, a sound environment es consisting of a single first sound object OS¹). The interaction request irq will then ask the user U to indicate the origin of the sound signal s¹, that is to say the direction in which the user U perceives a second sound object OS² following the spatialized reproduction of the first sound object OS¹.

FIG. 3a shows a user interface, in this case a screen 10 displaying the interaction request irq, for example a question relating to the location posₒₛ?, and if necessary a number of choices of answers iqcm: fposrp, lposrp, rposrp positioned on the display relative to a representation of the user's position urp. If necessary, the user interface, in this case the screen 10, offers an interaction area at the displayed choices, enabling the user to use a stylus, a mouse or touch interaction with the screen 10 to select one of the choice of answers displayed, namely fposrp, lposrp, rposrp. For example, the user hearing a sound on his right will select the position R, supplying a second data element matching a second location having the value “right” (rposrp).

In a particular embodiment, the characterization method comprises the determination of the second data on the basis of a position of a user's hand, for example his right hand or the hand holding a joystick of a virtual or augmented reality headset, or of a games console. Either the characterization method receives the joystick hand position, or the characterization method captures the hand position, notably by using a camera. Thus, if the user places his hand:
in front of him, the choice corresponds to fposrp in the positions offered by the interaction request,
on his right, the choice corresponds to rposrp in the positions offered by the interaction request,
on his left, the choice corresponds to lposrp in the positions offered by the interaction request.

If necessary, the user interface comprises an area ios for interaction with the first sound object, enabling the user to request the repetition of the spatialized reproduction of the first sound object.

If necessary, the user interface comprises an area islct for interaction with the selection of the first sound object, enabling the user to request the selection of a new sound environment and therefore of a new first sound object. Thus, if the first sound object creates particular perceptual problems for the user, he may change it in order to be characterized as an appropriate user and therefore to gain access to the device/service using the characterization method. This reduces false characterizations of users as inappropriate.

Thus the interaction request irq reproduced on the screen 10 is, for example, “Where do you hear this sound?” Either before the reproduction of the interaction request, or simultaneously with the reproduction of the interaction request, a sound is reproduced and the characterization method asks the user to react to it via the interaction request.

If necessary, an area for interaction with the sound ios. is also reproduced on the screen 10. This area ios for interaction with the sound comprises, notably, a reading interaction element. A user's action a relating to this interaction element triggers a check of the spatialized reproduction of the sound. For example, the interaction element is notably symbolized by a right-pointing triangle before the sound is broadcast and the reading of the sound is completed, by two broad lines while the sound is broadcast, and, at the end of the sound broadcast, by a triangle pointing to a vertical line on the left. Thus an action on the right-pointing triangle triggers the reading and spatialized reproduction of the sound, an action on the two broad lines triggers a suspension of the reproduction of the sound while allowing the spatialized reproduction of the sound to be resumed subsequently starting from the instant of pausing, and an action on the left-pointing arrow triggers a spatialized reproduction of the sound from the beginning of the sound. The area of interaction with the sound ios comprises, notably, a reading ruler, consisting of a horizontal line that fills progressively as the spatialized reproduction of the sound progresses (the line is empty at the start of the sound reproduction and full at the end of it). In particular, when the user acts on a particular point on this reading ruler, this triggers the spatialized reproduction of the sound starting from the instant of the sound signal represented by this point on the reading ruler. The area of interaction with the sound ios comprises, for example, a slider for interacting with the audio volume of the spatialized sound reproduction. The area of interaction with the sound comprises one or more of the following interaction elements: a reading interaction element, a reading ruler, and a volume slider.

In particular, the interaction request comprises instructions relating to the sound reproduction devices to be used. For example, it requests “listening via headset only”. Thus characterization errors due to non-spatialized reproduction of the sound object caused by the use of an unsuitable sound reproduction device will be avoided.

If necessary, the multiple choices offered will be in text form, such as “front” for the choice fposrp, “right” for the choice rposrp, and “left” for the choice lposrp, and/or will be represented graphically by a symbolic diagram of a user urp, and boxes or circles that can be selected, by ticking for example, as shown in FIG. 3a.

In particular, the area for selecting a new first sound object includes a reproduction of the following prompt: “Not found? Generate another sound.”

If necessary, the same sound or different sounds reproduced at different instants, notably in a given order, may move in the 3D audio scene through a series of N first locations. This forms a series of sound objects.

In a first implementation of the characterization method, for each sound object in the series, that is to say for each new position of a sound (either the same or a new sound), the characterization method triggers a display on the screen 10 of FIG. 3b and waits for the user's action. The change to a new position of the sound and/or to a new sound object is then dependent on a positive result of comparison, that is to say on the user's correct identification of the actual position of the actual sound object (this means that the second data element matching the location of the perceived sound object, that is to say the second sound object, by the user corresponds to the first data element matching the actual location of the sound object during spatial reproduction, that is to say the location of the first sound object).

In a second implementation of the characterization method, the set of sound objects in the series is reproduced spatially in the order determined by the series (at the instant specified by the series, for example). The characterization method triggers a display of the screen 10 of FIG. 3b and waits for the user's action. The interaction request irq reproduced on the screen 10 is then, for example, “Indicate the different directions, in order, from which you have heard a sound”. The characterization method then receives a series of user actions {a(n)}n=1 . . . N, each indicating at least a second location. The characterization method triggers the comparison after the series of actions has been completed and converted into a series of second data based on these actions: {d2(n)=f(a(n))}n=1 . . . N. The comparison CMP verifies, for each first data element d₁(n) associated with a first sound object reproduced at an instant n, whether the second data element d2(n) supplied by the user for this instant n (because it is associated with the n-th user action) corresponds to this first data element d1(n). The comparison triggers a characterization of the user as an appropriate user if the series matches, in the order of the series. For example, if the user indicates that he has heard a sound on the right initially, then in front, and then on the right again. And, since the series of first sound objects corresponded to a first location of a first sound object on the right, then in front, and then on the right, the user is characterized as an appropriate user. Conversely, if the user indicates that he has heard a sound on the right, on the left and then on the right, the user is characterized as an inappropriate user.

FIG. 3b shows a simplified diagram of a user interface of a second embodiment of the invention in the event of an interaction request relating to a position of a sound object.

It is also possible to have different sounds coming from three or more directions. The user must locate a given type of sound (a cat, for example).

In the case of FIG. 3b, the 3D audio scene comprises, in particular, a plurality of sound objects in different categories tyₒₛ. The position request generation POSRQ_GN receives selection information from the selection of sound objects OSi_SLCT and generates an interaction request irq, comprising not only a question irqq but also a subject irqsbj. The question irqq relates, notably, to the location posₒₛ? of a sound object, and the subject indicates that the question relates to a specific sound object by indicating that it is a sound object for which the value of another characteristic parameter is that of the first sound object selected; for example the interaction request asks for the location of a sound object of the type tyₒₛ, namely an animal noise, or more precisely a cat, a donkey, or other.

Thus, the interaction request irq reproduced on the screen 10 is, for example, “Where do you hear the cat?” If necessary, an area of interaction with the sound ios is also reproduced on the screen 10. The area of interaction with the sound comprises one or more of the following interaction elements: a reading interaction element, a reading ruler, and a volume slider. In particular, the interaction request comprises instructions relating to the sound reproduction devices to be used. For example, it requests “listening via headset only”.

If necessary, the response area is formed by an input area iz, or by offered multiple choices iqcm, which are in text form, such as “front” for the choice fposrp, “right” for the choice rposrp and “left” for the choice lposrp, and/or is represented graphically by a symbolic diagram of a user urp and boxes or circles that can be selected, by ticking for example, as shown in FIG. 3a.

In particular, the area for selecting a new first sound object includes a reproduction of the following prompt: “Not found? Generate another sound.”

If necessary, the cat may move in the 3D audio scene through a series of N first locations. This forms a series of sound objects.

In a first implementation of the characterization method, for each sound object in the series, that is to say for each new position of the cat, the characterization method triggers a display of the screen 10 of FIG. 3b and waits for the user's action. The change to a new position of the cat is then dependent on a positive result of comparison, that is to say on the user's correct identification of the actual position of the cat (meaning that the second data element matching the location of the cat perceived by the user corresponds to the first data element matching the actual location of the cat during its spatial reproduction).

In a second implementation of the characterization method, the set of sound objects in the series, that is to say the cat in its different positions, is spatially reproduced. The characterization method triggers a display of the screen 10 of FIG. 3b and waits for the user's action. The interaction request irq reproduced on the screen 10 is then, for example, “Indicate the order of the different directions where you heard the cat from.” The characterization method then receives a series of user actions {a(n)}n=1 . . . N , each indicating at least a second location. The characterization method triggers the comparison after the series of actions has been completed and converted into a series of second data based on these actions: {d2(n)=f(a(n))}n=1 . . . N. The comparison CMP verifies, for each first data element d₁(n) associated with a first sound object reproduced at an instant n, whether the second data element d2(n) supplied by the user for this instant n (because it is associated with the n-th user action) corresponds to this first data element d1(n). The comparison triggers a characterization of the user as an appropriate user if the series matches, in the order of the series. For example, if the user indicates that he heard the cat on the right initially, then in front and then on the right again. Since the series of first sound objects corresponded to a first location of the cat on the right, then in front, then on the right, the user is characterized as an appropriate user. Conversely, if the user indicates that he has hear the cat only three times on the right, the user is characterized as an inappropriate user.

In particular, the user locates the sound object on the screen 10 by interaction relative to a representation of the user's position urp. The characterization method then determines the position supplied by the user and uses the position of the sound object thus determined in the comparison. The advantage of the free placing of the position on the screen is that it is more difficult for an algorithm to evade.

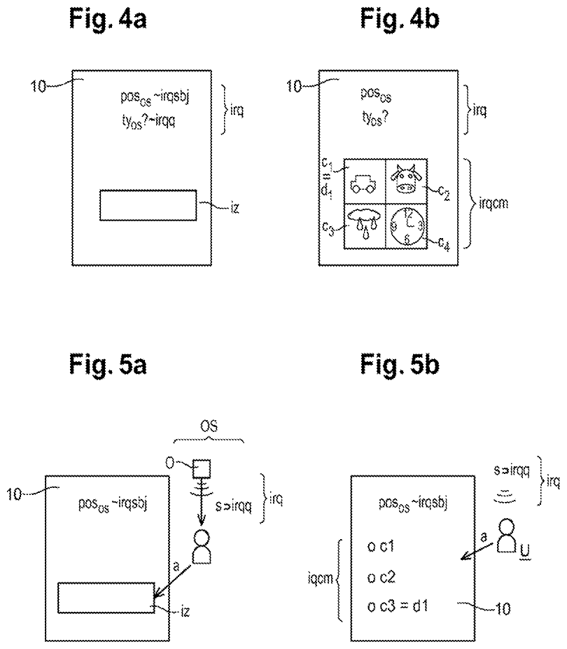

FIG. 4a shows a simplified diagram of a user interface of a first embodiment of the invention in the case of an interaction request relating to a category of a sound object.

It would also be possible to have different sounds, in terms of their sound source categories, coming from three (or more) directions. The user must indicate the type of sound associated with a given position (e.g. right).

In the case of FIG. 4a, the 3D audio scene comprises, in particular, a plurality of sound objects at different locations posₒₛ. The category request generation TYRQ_GN receives selection information from the selection of sound objects OSi_SLCT and generates an interaction request irq comprising not only a question irqq but also a subject irqsbj. The question irqq relates, notably, to the category tyₒₛ? of the source of a sound object, and the subject indicates that the question relates to a specific sound object by indicating that it is a sound object positioned at a location having a value matching that of the first sound object selected; for example, the interaction request asks for the category of a sound object located at posₒₛ on the right.

Thus the interaction request irq reproduced on the screen 10 is, for example, “What is the origin of the sound on the right?” If necessary, an area of interaction with the sound ios is also reproduced on the screen 10. The area of interaction with the sound comprises one or more of the following interaction elements: a reading interaction element, a reading ruler, and a volume slider. In particular, the interaction request comprises instructions relating to the sound reproduction devices to be used. For example, it requests “listening via headset only”.

If necessary, the response area consists of an input area iz in which the user enters his answer by means of a keyboard or a stylus, for example.

In particular, the area for selecting a new first sound object includes a reproduction of the following prompt: “Not found? Generate another sound.”

If necessary, different sounds, notably a series of N first sound objects associated respectively with N first categories, may follow one another in the same location of the 3D audio scene.

In a first implementation of the characterization method, for each sound object in the series, that is to say for each new category of sound, the characterization method triggers a display of the screen 10 of FIG. 3a and waits for the user's action. The change to a new sound is then dependent on a positive result of comparison, that is to say on the user's correct identification of the actual category of the sound on the right (meaning that the second data element matching the category perceived by the user corresponds to the first data element matching the actual category of the sound object being spatially reproduced).

In a second implementation of the characterization method, the set of sound objects in the series is spatially reproduced; that is to say, a plurality of sound objects are successively spatially reproduced on the right. The characterization method triggers a display of the screen 10 of FIG. 3a and waits for the user's action. The interaction request irq reproduced on the screen 10 is then, for example, “Indicate the different categories of sounds heard on the right, in order.” The characterization method then receives a series of user actions {a(n)}n=1 . . . N, each indicating at least one second category. The characterization method triggers the comparison after the series of actions has been completed and converted into a series of second data based on these actions: {d2(n)=f(a(n))}n=1 . . . N. The comparison CMP verifies, for each first data element d₁(n) associated with a first sound object reproduced at an instant n, whether the second data element d2(n) supplied by the user for this instant n (because it is associated with the n-th user action) corresponds to this first data element d1(n). The comparison triggers a characterization of the user as an appropriate user if the series matches, in the order of the series. For example, if the user indicates that he has initially heard a cat on the right, then a car, and then a cat again. Since the series of first sound objects matched a first category having the value of cat, car, and then cat, the user is characterized as an appropriate user. Conversely, if the user indicates that he has only heard a cat three times on the right, the user is characterized as an inappropriate user.

FIG. 4b shows a simplified diagram of a user interface of a second embodiment of the invention in the event of an interaction request relating to a category of a sound object.

The difference from the user interface of FIG. 4a lies in the interaction area, which comprises a multiple choice of answers iqcm. In this case, the multiple choice comprises a mosaic of four interaction elements, c1, c2, c3 and c4, corresponding to four choices of different answers. On each interaction element of the mosaic there is a reproduction, notably, of content associated with a value of the category of sound source, such as an image, a video, or other. The choices offered include a choice corresponding to the first data element d1, that is to say the value of the first category associated with the first sound object selected, reproduced spatially.

In the example of FIG. 4b, the choice c1 corresponds to a category having the value “car”, while the value is “cow” for c2, “rain” for c3, and “clock” for c4. Thus, if the first spatially reproduced sound object to be selected is a car, the spatially reproduced sound will be, for example, the noise of a car engine at the first location, on the right for example. The cow may be associated with the sound signal of a noise made by a cow, i.e. a moo, while for the rain it is the patter of rain on a surface, and for the clock it is a ticking sound.

Thus, after the reproduction of the interaction request asking the user for the category corresponding to the sound on the right, if the user selects the picture c1 from the mosaic of multiple choices iqcm, the comparison will characterize the user as an appropriate user. Conversely, if the user selects any of the other pictures c2, c3 or c4, the comparison will characterize the user as an inappropriate user.

When a series of sound objects are used for characterization, the advantage of the mosaic is that it facilitates user interaction while limiting errors in characterization. If the series reproduced on the right is a cow, a car, and a cow, then the user selecting the pictures c1, c2 and then c2 will be characterized as an appropriate user.

FIG. 5a shows a simplified diagram of a user interface of a first embodiment of the invention in the case of a sound object comprising an interaction request.

If necessary, the different sounds correspond to different vocalized questions from three (or more) directions. The user must indicate the answer to the vocalized question irqq included in the sound s associated with a given position posₒₛ (e.g., right)

In the case of FIG. 5a, the 3D audio scene comprises, in particular, a plurality of sound objects at different locations posₒₛ. The response request generation DRQ_GN receives selection information from the selection of sound objects OSi_SLCT and generates an interaction request irq comprising only a subject irqsbj, since the question irqq is reproduced with the sound s. The subject indicates that the question is reproduced with a specific sound object, indicating that the sound object concerned is positioned at a location having a value matching that of the first sound object selected; for example, the interaction requests a response to the question put by a sound object posₒₛ located on the right.

Thus, if the interaction request irq reproduced on the screen 10 is, for example, “Answer the question coming from your right”, or “Please answer the person speaking to you on your right.” If necessary, an area of interaction with the sound ios is also reproduced on the screen 10. The area of interaction with the sound comprises one or more of the following interaction elements: a reading interaction element, a reading ruler, and a volume slider. In particular, the interaction request comprises instructions relating to the sound reproduction devices to be used. For example, it requests “listening via headset only”.

If necessary, the response area consists of an input area iz in which the user enters his answer by means of a keyboard or a stylus, for example.

In particular, the area for selecting a new first sound object includes a reproduction of the following prompt: “Not found? Generate another sound.”

If necessary, different sounds, notably a series of N first sound objects associated, respectively, with N first answers (that is to say, the N sound signals of these objects comprise, respectively, one of the N vocalized questions corresponding to these N first answers), may follow one another in the same location of the 3D audio scene.

In a first implementation of the characterization method, for each sound object of the series, that is to say for each new question vocalized, the characterization method triggers a display of screen 10 of FIG. 3b and waits for the user's action. The change to a new sound is then dependent on a positive comparison result, that is to say on the fact that the user provides a correct answer to the question vocalized in the right-hand sound (this means that the second data corresponding to the answer to the question perceived by the user corresponds to the first data corresponding to the answer to the question actually vocalized by the sound object while it is spatially reproduced.

In a second implementation of the characterization method, all the sound objects of the series are reproduced spatially; that is to say, a plurality of sound objects are successively reproduced spatially on the right, and in this case a plurality of questions are asked in succession on the right. The characterization method triggers a display of screen 10 of FIG. 3a and waits for the user's action. The interaction request irq reproduced on screen 10 is then, for example, “State, in order, the different answers to the questions asked on your right.” The characterization method then receives a series of user actions {a(n)}n=1 . . . N, each indicating at least one second answer. The characterization method triggers the comparison after the series of actions has been completed and converted into a series of second data based on these actions: {d2(n)=f(a(n))}n=1 . . . N. The comparison CMP verifies, for each first data element d₁(n) associated with a first sound object reproduced at an instant n, whether the second data element d2(n) supplied by the user for this instant n (because it is associated with the n-th user action) corresponds to this first data element d1(n). The comparison triggers a characterization of the user as an appropriate user if the series matches, in the order of the series. For example, if the user answers the vocalized questions, for example “Who is the American President?”, “How much is 1 plus 1?”, “Which continent is France in?”, heard on the right, with “Biden” first, then “2”, and then “Europe.” Since the series of first sound objects corresponded to a first answer with the value of “Biden”, “2”, and then “Europe”, the user is characterized as an appropriate user. Conversely, if the user answers the vocalized questions heard on the right with “Macron”, “2”, and then “Europe”, the user is characterized as an inappropriate user.

FIG. 5b shows a simplified diagram of a user interface of a second embodiment of the invention in the case of a sound object comprising an interaction request.

The difference from the user interface of FIG. 5a lies in the interaction area, which comprises a multiple choice of answers iqcm. In this case, the multiple choice comprises a list of three interaction elements c1, c2 and c3, corresponding to three choices of different answers. For each interaction element on the list, there is reproduced, notably, a text corresponding to a value of a first answer. The choices that are offered include a choice corresponding to the first data element d1, in this case c3, that is to say the value of the first answer associated with the first selected sound object reproduced spatially and containing a vocalized question.

The advantage of the list, in the case where a series of sound objects are used for characterization, is that it facilitates the user interaction while limiting the characterization errors. If the answers to the questions vocalized with the series reproduced on the right are c3, c1 and then c2, Then the user selecting the list elements c3, c1, and c2 will be characterized as an appropriate user.

If necessary, if the series relates to a given location, the question in the interaction request may apply to different characteristic parameters of the sound objects of the series. For example, the interaction request asks the user to listen to the right-hand sound. For the first object, he will provide a category value of the sound object reproduced spatially on the right; for the second, he will answer the question asked vocally; for the third, the answer may again be category value, and so on. It should be noted that a sound object comprising a vocalized question may be associated with a category value corresponding to a person or voice category, such as man, woman, child, shrill, serious, loud, murmuring, English accent, southern accent, etc.

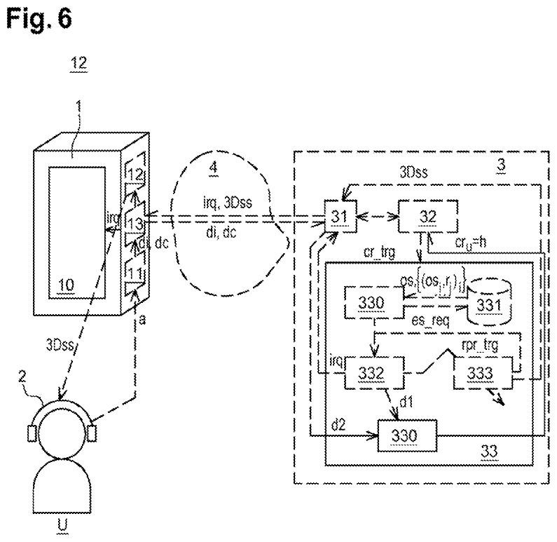

FIG. 6 shows a simplified diagram of a communication architecture comprising a characterization device according to an exemplary embodiment of the invention.

The device 33 for characterizing a user U comprises a comparator 334 for comparing first data d1, associated with a first sound object OS¹ spatialized at a first location pos¹ₒₛ of an audio scene 3DES spatialized by a user interface 2 of a communication terminal 1, with second data d2 received following the reproduction of the first spatialized sound object OS₁, the first data d1 being distinct from the first sound object OS₁, the second data d2 being based on a second spatialized sound object OS² perceived at a second location pos²ₒₛ of the spatialized audio scene 3DES, the comparator 334 triggering, in the event of a positive result, a characterization of the interaction source as an appropriate user.

In particular, the characterization device 33 comprises a selector 330 of a sound environment from a storage device 331, such as a memory or a database, comprising one or more predefined sound environments. In particular, the database is a database of sounds or a database of sound objects, or even a database of sound environments. The sound environment selector 330 receives from the storage device 331 a sound environment es composed of:
either one or more first sound objects OS₁, {OS¹ᵢ}ᵢ,
or one or more pairs formed by:
   a first sound object and a first location (OS¹, pos¹ₒₛ), {(OS¹ᵢ, pos¹ₒₛᵢ)}ᵢ, or
   a first sound object and a first category of sound sources (OS¹, ty¹ₒₛ), {(OS¹ᵢ,ty¹ₒₛᵢ)}ᵢ, or
   a first sound object and a first answer to a vocalized question included in the first sound object (OS¹, r¹ₒₛ=d1), {(OS¹ᵢ, r¹ₒₛᵢ)}ᵢ,
   etc.
or one or more n-uplets formed by a first sound object and one or more of the following parameters: a first location, a first category of sound sources, a first answer, etc. (OS¹, pos¹ₒₛ, ty¹ₒₛ), {(OS¹ᵢ, pos¹ₒₛᵢ, ty¹ₒₛᵢ)}ᵢ, (OS¹, pos¹ₒₛ, r¹ₒₛ=d1), {(OS¹ᵢ, pos¹ₒₛᵢ, r¹ₒₛᵢ)}ᵢ, (OS¹ᵢ, ty¹ₒₛ, r¹ₒₛ=d1), {(OS¹ᵢ, ty¹ₒₛᵢ, r¹ₒₛᵢ)}ᵢ(OS¹, pos¹ₒₛ, ty¹ₒₛ, r¹ₒₛ=d1), {(OS¹ᵢ, pos¹ₒₛᵢ, ty¹ₒₛᵢ, r¹ₒₛᵢ)}ᵢ, etc. Notably, the sound environment selector 330 sends a request for a sound environment es_req to the storage device 331, and receives the sound environment es in response to the sound environment request es_req.

In particular, the characterization device 33 comprises a generator 332 of an interaction request irq relating to a first sound object: either the only sound object OS¹ or a selected sound object Os1j¹ⱼ in the sound environment es. The interaction request irq relates to one or more characteristic parameters of the first sound object OS¹, OS¹ⱼ.

In particular, the generator 332 of the interaction request irq comprises one or more of the following devices (not shown):
a verifier of the number of sound objects in the selected sound environment, i=1?;
if necessary, a selector for selecting a sound object from the selected sound environment;
a verifier of the presence of at least one characteristic parameter associated with the first selected sound object OS¹ⱼ: notably, a verifier of the presence of an answer to a question vocalized in the first selected sound object, and a verifier of:
at least one generator of a specific interaction request, notably a generator of an interaction request relating to the location of the first object, and/or a generator of an interaction request relating to the question vocalized in the first sound object, and/or a generator of a request relating to a source category, etc.;
a request selector;
etc.

The interaction request generator 332 supplies to an interaction request reproduction device 10, 2 an interaction request irq relating to a first sound object, or to a first series of sound objects, possibly comprising one or more specific requests relating to a characteristic parameter associated with the first sound object, or to the first series of first sound objects. The interaction request reproduction device is, notably, a visual reproduction device such as a display on a screen 10, a virtual or augmented reality headset, etc. (the visual reproduction being preliminary to or simultaneous with the reproduction of the spatialized sound environment 3D_RPR, and/or a sound reproduction device 2, the reproduction of the interaction request then being preliminary to the reproduction of the spatialized sound environment.

In particular, the spatialized sound environment reproduction device 2 is controlled and triggered by one of the following devices: the sound environment selector 330, the interaction request generator 332, and the reproduction device 10, 2, during the reproduction of the interaction request.

Following the reproduction of the interaction request IRQ_RPR, the user U_{H}, U_{R} reacts a by supplying second data d2 relating to a second sound object OS² by means of a user interface 10, 11 of the communication terminal 1. The second sound object OS² is the sound object whose second sound signal or second sound s² is perceived by the user in the reproduced spatialized sound environment 3DES which, for the user, corresponds to the first sound object OS1 to which the reproduced interaction request irq relates.

The characterization device 33 receives these second data d2 from the user, possibly from a user interface of the communication terminal 1. In particular, the characterization device 33 comprises one or more of the following devices (not shown):
a data receiver for receiving data from a user interface, notably captured data dc or an action a, and for supplying received data dr;
an extractor of second data XTR from received data dr and/or captured data dc.

Notably, the user interface 10, 11 comprises one or more of the following devices (not shown):
a sensor such as a camera, a microphone, a touch screen, or the like, for sensing an action a of the user, supplying captured data dc;
a data receiver, for receiving data input by the user on a peripheral (not shown), such as a keyboard, a mouse, or the like, of the communication terminal 1.

In particular, the creation of a spatialized sound environment 3D_GN and/or the check of reproduction CNT and/or the reproduction of the sound environment 3D_RPR trigger an interaction processing IRTRT and/or a capture CPT and/or a reception of data RCV.

In particular, the comparator 334 triggers, in the event of a positive result [N], a characterization of the interaction source as an inappropriate user cr_{U}=ia.

In a particular embodiment, the communication architecture comprises a service provision device 3. The service provision device comprises:
a processor 32 for implementing at least one service;
an interface 31 for exchanges with a communication terminal 1; and
a device 33 for characterizing a user of the service, comprising a comparator 334 for comparing first data, associated with a first spatialized sound object at a first location of a spatialized audio scene by a user interface of the user's communication terminal, with second data received following the reproduction of the first spatialized sound object, the first data d1 being distinct from the first sound object OS₁, the second data being based on a second spatialized sound object perceived at a second location of the spatialized audio scene, the comparator triggering, in the event of a positive result, a characterization of the interaction source as an appropriate user, and commanding the processor to implement the service.

In particular, the characterization device 33 is activated by the service provision device 3, particularly before the provision of the service. The service provision will be triggered by the characterization of the interaction source as an appropriate user, in particular a human user. If necessary, if the interaction source is characterized as an inappropriate user, in particular a robot user or software agent, the characterization method triggers the stopping of the service provision device 3.

In the example of FIG. 6, the communication architecture comprises a characterization device according to an exemplary embodiment of the invention 33, notably implemented in a service provision device 3 according to an exemplary embodiment of the invention. The user U who is to be characterized by the characterization device 33 interacts, notably, with the characterization device 33 by means of a communication terminal 1 connected to the characterization device 33 and, if appropriate, to the service provision device 3, notably via a communication network 4. The characterization device 3 uses, notably, a headset 2 worn by the user U as a 3D sound or spatialized sound reproduction device. The headset 2 is, notably, a peripheral of the communication terminal 1.

For example, the user U wishes to download, via his communication terminal 1, content supplied by the service provision device 3. The communication terminal 1 requests the content (not shown) from the service provision device 3, which activates the characterization device 33 to avoid content request spam.

The sound environment selector 330 selects a sound environment es from the storage device 331. The interaction request generator 332 then uses at least one of the sound objects from the selected sound environment supplied by the selector 333 to create an interaction request irq. In the example of FIG. 6, the characterization device 33 comprises a controller 333 that commands the spatialized sound reproduction of the selected sound environment, notably by supplying a spatialized sound signal 3Dss.

If necessary, the interaction request generator 332 triggers rpr_trg the command for spatialized sound reproduction from the controller 333.

In particular, if the characterization device 33 and the spatialized sound reproduction device 2 are not co-located, the characterization device supplies the spatialized sound signal from the selected sound environment 3Dss to a transmitter 31 implemented in the characterization device 33 and/or in the service provision device 3 implementing the characterization device 33. The transmitter 31 transmits the spatialized signal 3Dss to the communication terminal 1, which receives it, notably, via a receiver 13. The receiver 13 supplies this spatialized signal 3Dss, notably via a peripheral interface 12, to the spatialized sound reproduction device 2.

In particular, if the characterization device 33 and the request reproduction device 10 are not co-located, the interaction request generator 332 supplies the generated request irq to a transmitter 31 implemented in the characterization device 33 and/or in the service provision device 3 implementing the characterization device 33. The transmitter 31 transmits the interaction request irq to the communication terminal 1, which receives it, notably, via a receiver 13. The receiver 13 supplies this request irq to the reproduction device 10, for example on the screen of the communication terminal 1.

The terminal 1 comprises a user interface 10, 11 that receives an action a of the user U following the reproductions of the interaction request and of the spatialized sound environment, and supplies received or captured data di, dc corresponding to this action a. These data di, dc are supplied to the characterization device 33, notably via a transmitter 13 of the communication terminal and a receiver 31 implemented in the characterization device 33 and/or in the service provision device 3 implementing the characterization device 33.

The comparator 334 then compares the second data d2 from the data received or captured di, dc from the communication terminal 1 with the first data d1 associated with the sound object selected by the interaction request generator 332. If there is a match between the first and second data d1, d2, then the comparator 334 characterizes the user U as appropriate (as a human user, for example) cr_{U}=h, and if necessary, notifies this to the service provision device 3, which then supplies the requested content.

In an embodiment which is not shown, the characterization device 33 is implemented in a communication terminal 1, notably the communication terminal 1 forming a service provision device.

In a particular embodiment which is not shown, the characterization device 33 is activated by a device for accessing a third-party device (such as a communication terminal 1, a connected object, remote equipment, etc.), particularly before the authorization of access to the third-party device. Access to the third-party device will be triggered by the characterization of the interaction source as an appropriate user, particularly a human user. If necessary, in the event of a characterization of the interaction source as an inappropriate user, particularly a robot user or software agent, the characterization method triggers a stop STP of the implementation of the method for accessing the third-party device.

In a particular embodiment, the controller 33 provides a pair of binaural filters which encodes the spatialized location of the sound object at the spatialized sound reproduction device. In particular, if the user requests another reproduction of the same sound object, the controller provides a pair of binaural filters distinct from the pair provided in the preceding reproduction. This causes a slight change in the perception of the location of the sound object.

This is because a pair of binaural filters represents the way in which a given human being physically perceives a sound originating from a given position in space when it reaches the vicinity of his auditory canals (one filter for the right ear and one for the left ear). The binaural filters are therefore individual, and, for a given human, only his own filters can correctly simulate the sound spatialization. However, for very strongly azimuthal positions (typically opposite the right ear, opposite the left ear, and facing the subject), modification of the binaural filters is not sufficient to block spatial perception. A random change of these filters with each CAPTCHA test, whether they are drawn from a previously established database, or modified algorithmically in real time, can make the characterization device more robust, because it adds a further difficulty, allowing recognition algorithms to be evaded.

An exemplary embodiment of the invention also proposes a data medium. The data medium may be any entity or device capable of storing the program. For example, the medium may comprise a storage means such as a ROM, for example a CD-ROM or a microelectronic circuit ROM, or a magnetic recording means such as a diskette or a hard disk.

On the other hand, the data medium may be a transmissible medium such as an electrical or optical signal which may be routed via an electrical or optical cable, by radio or by other means. The program according to an exemplary embodiment of the invention may, in particular, be downloaded from a network, notably a network of the internet type.

Alternatively, the data medium may be an integrated circuit in which the program is incorporated, the circuit being adapted to execute the method in question or to be used in its execution.

In another embodiment, the invention is applied by means of software and/or hardware components. In this context, the term “module” may equally well refer to a software component or a hardware component. A software component is one or more computer programs, one or more sub-programs of a program, or more generally any element of a program or a software package capable of performing a function or a set of functions according to the description below. A hardware component is any element of a hardware assembly capable of performing a function or a set of functions.

An exemplary embodiment of the invention makes it possible to add a new mode of characterization of the use, notably differentiation between a human user and a using machine which is more difficult to evade automatically. It could be used as a CAPTCHA test for visually impaired persons, since it is based on the recognition of a characteristic parameter relating to a sound object on condition that the interaction request is reproduced in a way that can be perceived by a visually impaired person, for example by voice reproduction or reproduction in relief (also known as Braille reproduction).

In a variant of the invention, the characterization method comprises the unlocking of a computer by requiring the user to put on his audio headset, for example, for an application where the use of sound is essential (e.g. advertising, instructions on an industrial site, switching on an earphone after making sure that one can hear well, etc.).

Thus the characterization method using 3D sound according to an exemplary embodiment of the invention may also be used to check that the headset is worn the right way round. This is an “augmented” CAPTCHA test that extends beyond the security aspect. It may be used to unlock an app by using the position of the 3D sound.

In the variant of the invention using sound spatialization techniques in surround means such as transaural, WSF, Ambisonic, 5.1 and the like, the characterization method may if necessary be used as a check of the correctness of the user's position relative to the sound scene. For example, the sound scene is presented to the user, and he is asked, for example, where the cow is. If his answer is wrong, he is asked to reposition himself with suitable instructions, and the procedure is restarted. This is particularly useful in the context of the calibration of a 3D sound system that has been newly purchased and received in the home. This operation makes it possible to ensure that the user is correctly positioned and will be able to make full use of the sound scene presented to him.

Although the present disclosure has been described with reference to one or more examples, workers skilled in the art will recognize that changes may be made in form and detail without departing from the scope of the disclosure and/or the appended claims.

1. A method for characterizing a user of a service, the method being implemented by a characterization device and comprising:
comparing first data, associated with a first sound object spatialized at a first location of an audio scene spatialized by a user interface of a communication terminal, with second data received following a reproduction of the spatialized first sound object, the first data being distinct from the first sound object, the second data being based on a spatialized second sound object perceived at a second location of the spatialized audio scene-; and
in response to a positive result of the comparing, triggering a characterization of an interaction source of the service as a suitable user.

2. The method for characterizing a user of a service as claimed in claim 1, wherein the first data and the second data belong to one of the following data types:
a location parameter of a spatialized sound object;
a category of sound object generating source;
an answer to a question voiced in a sound object.

3. The method for characterizing a user of a service as claimed in claim 1, wherein the method comprises reproducing an interaction request at the first spatialized sound object, the interaction request being intended for the interaction source, and the second data are data received following the reproduction of said interaction request.

4. The method for characterizing a user of a service as claimed in claim 3, wherein the interaction request comprises a type of the second data expected during an interaction with the user interface.

5. The method for characterizing a user of a service as claimed in claim 4, wherein the interaction request further comprises the second location of the second spatialized sound object, the second location corresponding to the first location.

6. The method for characterizing a user as claimed in claim 1, wherein the method for characterizing a user characterizes the user of at least one of the following elements:
a service implemented by a service provision device;
device from among the following devices:
the communication terminal;
a local or network processing device;
a service provision device;
a communication network equipment to which a communication terminal of the user is connected.

7. The method as claimed in claim 1, wherein the method comprises a check implemented by the user interface, the check checking the user interface by using a command for spatialized reproduction comprising the first sound object and the first location.

8. The method as claimed in claim 7, wherein the check triggers an activation of a capture of data by the user interface, the captured data comprising the second data received.

9. A non-transitory computer readable medium comprising a program stored thereon comprising program code instructions for executing the steps of the a method for characterizing a user of a service when said program is executed by a processor, wherein the method comprises:
comparing first data, associated with a first sound object spatialized at a first location of an audio scene spatialized by a user interface of a communication terminal, with second data received following a reproduction of the spatialized first sound object, the first data being distinct from the first sound object, the second data being based on a spatialized second sound object perceived at a second location of the spatialized audio scene; and
in response to a positive result of the comparing, triggering a characterization of an interaction source of the service as a suitable user.

10. A device for characterizing a user, the device comprising:
a processor; and
a non-transitory computer readable medium comprising instructions stored thereon which when executed by the processor configure the device to execute a method for characterizing a user of a service, the method comprising:
comparing first data, associated with a first sound object spatialized at a first location of an audio scene spatialized by a user interface of a communication terminal, with second data received following a reproduction of the spatialized first sound object, the first data being distinct from the first sound object, the second data being based on a spatialized second sound object perceived at a second location of the spatialized audio scene; and
in response to a positive result of the comparing, triggering a characterization of an interaction source of the service as a suitable user.

11. A service provision device, the service provision device comprising:
a processor capable of implementing at least one service;
an exchange interface for exchanges with a communication terminal; and
a device for characterizing a user of the service, comprising a comparator of first data, associated with a first spatialized sound object at a first location by a user interface of the communication terminal, with second data received following a reproduction of the first spatialized sound object, the first data being distinct from the first sound object, the second data being based on a second spatialized sound object perceived at a second location of the spatialized audio scene, the comparator triggering, in response to a positive result, a characterization of a source of interaction with the service provision device as an appropriate user, and commanding the processor to implement the service.

12. The method for characterizing a user of a service as claimed in claim 1, wherein the comparison result is positive when the first data and the second data are based on a same location, the first location of the first spatialized sound object associated with the first data being identical to the second location of the second spatialized sound object associated with the second data.
